(19) United States
(12) Patent Application Publication
(10) Pub. No.: US 2005/0102282 A1
(43) Pub. Date: May 12, 2005

(54) Method for personalized search

(75) Inventor: Greg Linden, Seattle, WA (US)

Correspondence Address: Greg Linden, 1415 E Valley St., Seattle, WA, 98112, US

(73) Assignee: Linden, Greg, Seattle, WA (US)

(21) Appl. No.: 10/961,974

(22) Filed: Oct. 12, 2004

Related U.S. Application Data
(60) Provisional application No. 60/517,895, filed on Nov. 7, 2003.

(51) Int. Cl. G06F 7/00

(52) U.S. Cl. 707/3

(57) ABSTRACT

A search tool provides a means of finding a set of items in a large collection of items using a search query. Personalized search generates different search results to different users of the search engine based on their interests and past behavior. The invention describes a method of providing personalized search using previous search queries of the user, pages viewed from previous search results, and the pages viewed by other users with similar searches.

### RELATED APPLICATIONS

This application claims the benefit of U.S. Provisional Application No. 60/517,895, filed Nov. 7, 2003.

### REFERENCES CITED

U.S. Patent Documents:

U.S. Pat. No. 5,761,662 June, 1998 Dasan 707/10
U.S. Pat. No. 5,754,939 May, 1998 Herz et al. 455/3.04
U.S. Pat. No. 6,182,068 March, 1999 Culliss 707/5
U.S. Pat. No. 6,618,722 July, 2000 Johnson et al. 707/5
U.S. Pat. No. 6,539,377 October, 2000 Culliss 707/5
U.S. Pat. No. 6,256,633 July, 2001 Dharap 707/10

### OTHER REFERENCES

E. J. Glover, S. Lawrence, M. D. Gordon, W. P. Birmingham, and C. L. Giles, “Recommending web documents based on user preferences,” ACM SIGIR 99 Workshop on Recommender Systems, Berkeley, Calif., August 1999.
Glen Jeh and Jennifer Widom, “Scaling personalized web search,” Stanford University Technical Report, 2002.
Taher H. Haveliwala, “Topic-Sensitive PageRank: A Context-Sensitive Ranking Algorithm for Web Search”, IEEE, 2002.
Taher Haveliwala and Sepandar Kamvar and Glen Jeh, “An Analytical Comparison of Approaches to Personalizing PageRank,” Stanford University Technical Report, 2003.

### DESCRIPTION

### FIELD OF THE INVENTION

The present invention relates to search engines and information filtering. More specifically, the invention relates to methods for improving search results using data about previous searches and items of interest for the current user and items of interest to other users.

### BACKGROUND OF THE INVENTION

The Internet is an extensive collection of documents, files, databases, articles, and other data. While most documents contain references (hyperlinks) to other documents, finding a document on a particular topic often requires the use of a search engine. Search engines examine most or all of the documents on the Internet and build an index over those documents. Users find documents using a search engine by issuing a search query that provides descriptive features of the desired items, including keywords, title words, topics, date of creation, and other fields. In many common instantiations, search tools return the set of matching items ordered by relevance to the search query. Relevance is often determined by frequency of keywords in a document, links between the document and other documents, and popularity of the document with other users of the search engine.

Personalized search enhances normal search by ordering the search results by the relevance to what the user and similar users have searched for and documents viewed in the past. Rather than treating each search query as independent of the last, the user's history of search queries, documents viewed, and topics of interest can be used to find or emphasize documents that otherwise would not be seen by the user.

### SUMMARY OF THE DISCLOSURE

The present invention is a method for generating personalized search results. An important benefit of the invention is that the user is able to more easily and more quickly find items of interest using a search engine. Another important benefit is that the search results are improved without any explicit information from the user; the user's previous searches, documents viewed by the user, and documents viewed by other users provide the information to personalize the search results implicitly.

The search is personalized in three ways: (1) Previous search results with similar search queries by this user modify the current search results for this user's query. For example, if a user first searches for “oak desk” and then searches for “solid oak desk”, the items shown in the search results from the first query would influence the ordering of the search results from the second query. (2) Items viewed in previous search results with similar search queries by this user modify the current search results for this user's query. For example, if the user searches for “economic policy”, clicks on several search result items for books on tax policy, then searches again for “economic theory”, the items clicked on in the first query will influence the ordering of the search results from the second query. (3) Items viewed by other users with similar search queries modify the current search results for this user's query. For example, if the user searches for “oak desk” and many other users who searched for “solid oak desk” viewed particular items in those search results, those items would be emphasized in the current user's search results.

Previous work on personalized search has focused on developing a coarse-grained profile of a user's interests and biasing the search results in a broad manner using this profile. For example, a user may have stated or displayed an interest in the subject cooking, so a system using coarse-grained personalized search would tend to favor cooking-related documents in the search results for this user. The method described in this invention provides finer granularity in personalizing search results, reordering individual documents rather than entire classes of documents.

### DETAILED DESCRIPTION OF PREFERRED EMBODIMENTS

The various features and methods of the invention will now be described in the context of a web-based search service of web documents. Those skilled in the art will recognize that the method is applicable to other types of search engines. By way of example and not limitation, personalized search also could be used for web-based searches of data files such as audio files, computer searches such library catalogs that are not available on the World Wide Web, searches of structured data such as real estate listings, and most general types of database queries.

Throughout the description of the preferred embodiments, implementation-specific details will be given on how various data sources could be used to personalize the search results. These details are provided to illustrate the preferred embodiment of the invention and not to limit the scope of the invention. The scope of the invention is set in the claims section.

To show how personalized search may be implemented, it is important to understand how an Internet search engine operates. An internet search engine consists of a web-based front end on top of a database containing indexes of documents. A user provides a search, often simply one or two keywords, and the search engine finds which documents contain those keywords using the indexes, and then returns a list of the documents.

Because most users will not examine more than the first few documents in the search results, the ordering of the search results is important. The most relevant or most useful documents should be placed as high in the results as possible. Many techniques have been used for ranking and ordering the search results, including the absolute and relative frequency of the keywords in the documents, the number of references to the document (usually in the form of hyperlinks), or the overall popularity of the document. All of these ranking techniques will show the same search results on a given query to any user, regardless of what the user has done in the past.

To personalize the search results, a record of the history of searches and documents viewed must be maintained for each user. In the preferred embodiment, the data is stored in a separate database called the history database. When the user enters a search query, the query and search results are stored in the history database. When the user views an item from the results from their search query, the viewing is recorded in the history database. In the preferred embodiment, the database is an in-memory server-side database maintaining the historical data for a limited period of time. However, storing the data in file-based system, on the client, for longer duration does not change the nature of the invention.

Influence of Previous Similar Queries' Search Results

The first method of personalizing the search results is to modify the search results based on search results returned from similar queries. When a user enters a search term, the search query is compared to recent previous search queries by the same user. If the search query is similar, then the search results from the previous queries will influence the search results from the current query.

In the preferred embodiment, items that appeared in the search results from similar previous queries are deemphasized in the current search results. The intuition is that the user already saw the top ranked search results from the previous query. If the item already was not of interest, showing the item again is not helpful.

Similar queries include synonyms of keywords (e.g. “beige shoes” and “tan shoes”) and search queries by all users that are correlated in time. On the latter, the historical data on all search queries on the search engine over all time are analyzed to find correlations between the queries. Queries that the same users tend to do close in time together will tend to be correlated. For example, if many users search for “side table” and “end table” within a few minutes of each other, these two search queries will be correlated in time. Strongly correlated search queries will be considered similar. Our preferred measure of correlation is based on conditional probability, but any of several measures of correlation can be used without changing the nature of the invention.

The algorithm used in the preferred embodiment to calculate similar queries is as follows:

```
Compile a list of search queries and user ids
Build an index of all the unique search queries for each user id
Build an index of all unique user ids for each search query
For each search query, S₁
  For each user id, U, that made query S₁
    For each search query S₂ made by user id U
      Increment N(S₁, S₂)
    Increment N(S₁)
For each user U
  Increment N(U)
For each search query, S₁
  For each search query, S₂
    Corr(S₁, S₂) = P(S₁|S₂)/P(S₁)
      = P(S₁ & S₂) / (P(S₁) * P(S₂))
      = N(S₁, S₂) / (N(S₁) * N(S₂) / N(U))
```

The list of search queries can be derived from the web server logs or from the history database. The user id is an identifier of which user is making the query; it can be a web cookie identifier, session identifier, IP address, or any other form of recognizing a unique user. N(S₁, S₂) is the number of users who made both query S₁ and S₂. N(S₁) is the number of users who made search query S₁. N(U) is the number of users of the search engine. P(S₁) is the probability that a user has made query S₁. P(S₁ & S₂) is the probability that a user has made both queries S₁ and S2. P(S₁|S₂) is the conditional probability, the probability that a user has made query S₁ given that the user has already made query S₂. Corr(S₁, S₂) is the correlation between S₁ and S₂. In the final calculation of conditional probability, the maximum of N(S₂) and 30 is used in the preferred embodiment in the denominator to compensate for very infrequently used queries. A query is considered similar if the correlation is greater than an arbitrary threshold. Only the top 20 of the most similar queries are retained.

Once similar queries have been identified and stored in a table for use by the search engine, the search results from similar queries can be used to modify the current results. In the preferred embodiment, we deemphasize items that were high up in the search results on the previous queries. Specifically, if any of the the top N items (where we set N arbitrarily to 10) in any of the similar previous search results would have appeared in the current search results, they are moved further down in the search results, giving items that might not have already been seen a higher ranking as a result. In our preferred embodiment, the matching items are moved down (X−10) ranks in the current search results where X was the highest rank in any of the similar previous queries, but other penalties or methods of reordering could be used without changing the nature of the invention.

Influence of Previously Viewed Items from Similar Previous Queries

The second method of personalizing the search results is to use previously viewed items from similar queries to modify the current results. In the preferred embodiment, items clicked on in similar previous queries are assumed to have been of interest to the user. The system finds other similar items to the clicked on item and, if they appear in the current search results, moves those items up higher in the ranking.

To implement this system, we need to be able to determine similar queries and similar items. As described above, similar queries include synonyms of the current query and queries that appear to be correlated in time when analyzing the historical patterns of searches of all users. Similar items are items that are correlated in time when analyzing the historical patterns of the pages viewed from the search results of all users. Specifically, we examine the data on what pages were viewed from the search results. If many users view the same two items from search results in close proximity in time when using the search engine, those items are correlated in time. Strongly correlated pages are considered similar. Again, our preferred measure of correlation is conditional probability, but other measures of correlation could be used.

Given a method of identifying similar queries and similar items, we can implement the personalized search. For the current search query and search results, we find previous similar searches. For each previous similar search, we retrieve the items viewed from those search results. For each item viewed from the previous similar search results, we determine the similar items viewed by other users. For each of the similar items, if they appear in the search results of the current query, we bias them upward in the search results.

For example, if the user searched for “personalization”, clicked on a particular technical article listed in the search results, then searched for “personalization systems,” the system would recognize that these two queries are similar, find that the user clicked on a particular article in the last search, look up all the similar items for that article, and determine if any of the similar items appear in the current search results. If any of the similar items are in the current search results, they would be moved upward in the rankings to emphasize them.

In the preferred embodiment, if any of the similar items are found in the current search results, they are moved upward (currently arbitrarily set at 20% of their current rank). However, any of a number of other methods of reordering the search results based on the similar items, including modifying the original relevance rank, could be used without changing the nature of the invention.

Influence of Viewed Items for Similar Queries by Other Users

The third method of personalizing the search results is to use the items that other users viewed in similar queries to influence the search results from the user's current query. Items clicked on by users in their search results are assumed to be of interest to other users making the same or similar queries.

In the preferred embodiment, the user's current query is matched to a short list of similar queries. For each of the similar queries, the system determines the most popular items clicked on by all users for those queries. If those items appear in the current search results, they are moved upward in the rankings.

For example, if the user searches for “brown blanket”, the system would find all the similar searches to “brown blanket”, including “beige blanket”, “brown blankets”, and a few other similar searches. For each of those search queries, the system determines the items most frequently viewed by all users who did that query, perhaps a few web pages for retailers selling particular brown-colored blankets. The most popular items from all the other user's queries are emphasized in the search results for the current user for his query “brown blanket”.

In the preferred embodiment, similar searches are found using the same technique described in the other two personalization methods described above. A summary table containing the most frequently viewed items for each search query is build by analyzing historical data of all the searches of all the users for the last several days. Using the summary table, a list of items other users found of interest for this search can be created. This list of popular items is compared to the search results for the user's current query and any item that matches is moved upward in the rankings (by an amount currently arbitrarily set to 10% of the normal rank for similar queries and 30% of the normal rank for identical queries).

Many other methods of biasing the search results using other user's queries can be used without changing the nature of the invention. While the preferred embodiment only examines a single query, matching the last N queries of the current user against other users is not a substantial change to the invention. While the preferred embodiment picks a particular method of using the popular items of similar searches to change the rankings in the search results, modifying the raw relevance rank or other methods of changing the rankings is not a substantial change to the invention.

This brief description is merely a summary of the most important features of the invention so that the embodiments and claims described below can be better appreciated by those skilled in the art. There are additional features of the invention that will be described in the claims. This description should not be regarded as limiting the application of this invention.

Summary

The invention provides three methods of personalizing search. First, previous search results from similar queries by the user influence the search results from the current query. Second, items previously clicked on in similar queries by the user influence the search results from the current query. Third, items viewed by other users who had similar search queries influence the search results from the current query.

All three of these methods can either be implemented as part of the core search engine or as a post-processing step reordering the results returned from a normal search engine. Our preferred embodiment of the invention is the latter, but integrating the personalized search result ranking into the core engine does not change the nature of the invention.

1. In a multi-user computer system that provides user access to a database of items, a method of providing personalized search results from the database, the method comprising the computer-implemented steps of:
(a) generating a data structure which maps individual search queries in a database to corresponding sets of similar queries where similarity is based at least in part upon correlations between queries made by users of the search engine;
(b) generating a data structure which maps individual search result items in a database to corresponding sets of similar items in which similarities between items are based at least in part upon correlations between items viewed by users of the search engine;
(c) for a search query, accessing the data structure in step (a) to identify a corresponding set of similar queries;
(d) for search result items, accessing the data structure in step (b) to identify a corresponding set of similar search result items; and
(e) modifying search results for a given search query based at least in part on similar queries and similar search result items;
wherein step (a)-(b) is performed in an off-line mode, and steps (c)-(e) are performed substantially in real time in response to an online action by the user.

2. The method of claim 1, wherein step (e) comprises of emphasizing search results items frequently viewed by other users on similar search queries.

3. The method of claim 1, wherein step (e) comprises of deemphasizing search result items previously shown to the user for similar search queries.

4. The method of claim 1, wherein step (e) comprises of emphasizing search result items that are similar to search result items viewed by the user on previous search queries that are similar to the current search query.

5. A method of modifying results from a database of items comprised the computer-implemented steps of:
(a) accessing the database using a search query;
(b) accessing a database containing a history of queries and search results viewed by the user;
(c) accessing a database containing similar search queries for any given search query;
(d) accessing a database containing the most popular search result items for any given search query;
(e) accessing a database containing similar search result items for any given search result item;
(f) modifying the search results produced in step (a) using the set from step (b);
(g) modifying the search results produced in step (a) using the set from step (c);
(h) modifying the search results produced in step (a) using the set from step (d);
(i) modifying the search results produced in step (a) using the set from step (e);
(j) combining the modified search results from steps (f)-(i).

6. The method of claim 5, wherein the database in step (a) is a web-based search engine.

7. The method of claim 5, wherein step (b) is an in-memory database containing a finite history of the queries and search results for the queries.

8. The method of claim 5, wherein the database in step (c) is built from the history of user's searches on the database.

9. The method of claim 5, wherein the database in step (c) is built at least in part by analyzing correlations between search queries made by users of the search engine.

10. The method of claim 5, wherein the database in step (e) is built at least in part by analyzing correlations between search result items viewed by users of the search engine.

11. The method of claim 5, wherein steps (f) and (g) reduce the rank of search result items previously seen by the user for the same or similar search queries.

12. The method of claim 5, wherein step (h) increases the rank of search result items popular with other users making similar search queries.

13. The method of claim 5, wherein step (i) increases the rank of search result items that are similar to search result items previously viewed by the user for the same or similar search queries.

14. A method of searching a database of items where the search results are modified based on previous similar search queries, the method comprising of:
(a) finding similar search queries at least in part by analyzing correlations between the searches of users of the search engine;
(b) increasing the rank of search result items for the current search query that were frequently viewed by other users of the search engine when they executed a search query similar to the current user's search query.

15. A method of searching a database of items where the search results are modified based on previous similar search queries, the method comprising of:
(a) finding similar search queries at least in part by analyzing correlations between the searches of users of the search engine;
(b) decreasing the rank of search result items for the current search query that were previously seen by the user on similar search queries.

16. A method of searching a database of items where the search results are modified based on similarities between search result items, the method comprising of:
(a) finding similar search result items at least in part by analyzing correlations between the search result items viewed by users of the search engine;
(b) finding similar search queries at least in part by analyzing correlations between the searches of users of the search engine;
(c) increasing the rank of a search result items for the current search query that are similar to a search result item previously viewed by the user on the same or a similar search query.
